(19) United States
(12) Patent Application Publication
(10) Pub. No.: US 2004/0268238 A1
(43) Pub. Date: Dec. 30, 2004

(54) Systems and methods for processing documents using an XML-based process flow description language

(76) Inventors: Peiya Liu, East Brunswick, NJ (US); Liang H. Hsu, West Windsor, NJ (US)

Correspondence Address: Siemens Corporation, Intellectual Property Department, 170 Wood Avenue South, Iselin, NJ, 08830, US

(21) Appl. No.: 10/609,711

(22) Filed: Jun. 30, 2003

(51) Int. Cl. G06F 15/00

(52) U.S. Cl. 715/513

(57) ABSTRACT

Systems and methods for document processing using XML-based template server pages. An XML-based Process Flow Description Language (PFDL) is employed to describe a processing model for specifying a processing sequence of XML-based template sever pages, which supports development of Web-based applications and services. A processing model for processing XML-based template server pages is preferably based on an extensible, XML-based, pipeline processing model that specifies a collection of template processors (XML applications) that are executed in a specified sequence for processing XML-based templates, and which can interpret processor-specific XML elements within the templates.

### TECHNICAL FIELD

The present invention relates to systems and methods for document processing using document templates. Further, the present invention relates to systems, methods and applications that implement an XML-based PFDL (Process Flow Description Language) for providing active document template processing using computation specifications that are specified within XML-based templates.

### BACKGROUND

In general, document processing systems and methods provide various types of computation tasks as required for transforming document formats and structures, particularly in dynamic web page generation. For example, with respect to server-side document processing of Web documents on the WWW (world Wide Web), a process for dynamically generating a Web document typically comprises receiving client requests (e.g., URL and input data) from a client application, followed by server-side data source connection, content access from server-side database, document transformation, and then web page generation.

The development of open standards such as XML (extensible Markup Language) has led to more efficient and effective methods for document processing, wherein the documentation process can be automated in many areas in document lifecycle.

As is known in the art, XML is an extensible text format standard, which has been developed for use with large-scale electronic publishing and network exchange of various types of data, for example. XML allows authors and providers to design their own document markup (see, e.g., XML Extensible Markup Language (XML) 1.0 (Second Edition) W3C Recommendation 6 Oct. 2000).

Conventionally, Web applications were developed using low-level programming languages by writing programs and scipts. With the development of higher level n-tier application designs that enable separation of content, business logic and presentation, template processing methods have been used to describe the data independent portions of Web applications, such as introductory pages, forms, general page layout, etc.

In general, application authors can create templates that define the layout and sructure of a set of pages using, e.g., HTML or XML vocabularies. Conventional templating methods for document processing include “passive” template and “active” template processing methods. Passive template methods have limitations with respect to document processing specifications. Indeed, passive template methods normally specify generic document structure layout and content instantiation, wherein computation specifications are hard-coded in the template interpretation program. Such passive template methods are typically rigid and do not allow document structures to be dramatically modified, which is disadvantageous for Web-based applications, for example, which typically require various computation tasks for serving client requests.

On the other hand, “active” document template processing techniques are highly desirable for Web-based applications. In general, active template processing methods enable dynamic content generation via server-side processing, for example. For example, Active Server Pages™ (or “ASP”) and Java Server Pages™ (or “JSP”) are examples of well-known active template processing protocols that are used for dynamically composing/updating and delivering pages. These methods enable the development of dynamic, interactive front-ends for Web applications.

More specifically, as is well-known in the art, JSP is a technique that enables separation of content generation and page layout, which enables application developers to create Web applications using Web pages that display dynamically-generated content. In general, JSP documents are text-based documents that are authored using markup vocabularies (such as static HTML, XML, etc.) to include static tags (e.g., HTML, XML), along with additional JSP-specific tags, declarations, and/or scripts, to encapsulate the logic that generates the dynamic content for the page. In contrast to static content that is delivered “as is” to clients, a JSP page undergoes server-side processing including interpreting the JSP page and converting the JSP page to a servlet which is compiled and loaded by a JSP engine to dynamically generate the content of the JSP page. During processing of a servlet associated with a JSP page, the JSP engine will pass the static formatting tags (e.g., HTML, XML) directly back to the response page. During dynamic content generation, a JSP page may call JavaBeans (or other Java components), which contain business and data logic for an application to perform processing on the server.

The JSP method enables separation of presentation, content and business logic, wherein JSP developers generate the business logic (e.g., Java components) that drives the content presented to the end user, and the custom JSP tags/elements that encapsulate pieces of business logic (reusable components), and wherein content authors generate presentation templates that use the components/elements (business logic) that are made available by the developers.

Similarly, an ASP is an HTML page that includes one or more scripts that are interpreted by a script interpreter on the web server to build or customize a page on the fly before sending the page to the requesting client.

Although template techniques such as JSP and ASP, etc., are suitable for web-based publishing environments, such methods do not implement XML syntax. As such, when handling XML-based documents, such methods must implement double parsing processing and can create performance issues with complex computation tasks.

Accordingly, given the increasing popularity and ubiquity of XML for, e.g., web-based application environments, it would be highly desirable to generate an active template system and method for providing document processing and application development based on configurable XML-based templates.

### SUMMARY OF THE INVENTION

The present invention relates to systems and methods for document processing using XML-based template server pages. In one embodiment of the invention, a method for processing documents comprises: executing a document template; obtaining template processing specifications that are specified within the document template to provide instructions for processing elements of the document template; and processing the elements within the document template by sequentially calling template processors that are specified in the template processing specifications.

Preferably, template processing specifications according to an embodiment of the invention are described using an XML-based Process Flow Description Language (PFDL), which describes a processing model for specifying a processing sequence of XML-based template sever pages. Such model supports development of Web-based applications and services. More specifically, a processing model for processing XML-based template server pages according to an embodiment of the invention is preferably based on an extensible, XML-based, pipeline processing model that specifies a collection of template processors (XML applications) that are executed in a specified sequence for processing XML-based templates, and which can handle processor-specific XML elements within the templates. For example, a processing model can specify a sequence of conditional logic processing, data access processing, document transformation processing and/or session handling, etc.

Preferably, document processing systems and methods according to the invention are based on template specifications within XML-based templates, wherein the semantics of such template specifications are used to direct the computation of XML template processors. For example, in one embodiment, pipeline process flow descriptions, which are used for directing the computational steps of the XML template processors, are implemented using standard XML syntax of processing instructions (PI) that are specified in the prologs of XML-based templates. In other words, a pipeline processing model according to an embodiment of the present invention is preferably based on a sequence of processing instructions that are specified within an XML-based template to direct the template processing. The processing instructions use standard XML syntax to describe processors and processor-related XML elements that are defined in a doctype attribute. As such, pipeline processing frameworks for processing template server pages according to the invention are extensible, enabling users to define custom XML template processors specified by custom DTDs (document type definition).

Systems and methods for pipeline processing XML-based template server pages according to the invention can be used for building various types of Web-based applications and services, such as a web-based product configuration application. A web-based product configuration application according to the present invention provides a framework for pipeline processing of XML template server pages to perform various product configuration tasks (which are specified in XML templates) such as configuration computation, transformation, connection and interaction.

These and other embodiments, aspects, features and advantages of the present invention will be described or become apparent from the following detailed description of the preferred embodiments, which is to be read in connection with the accompanying drawings.

### BRIEF DESCRIPTIONS OF THE DRAWINGS

FIG. 1 is a diagram of a system for template processing using XML-based process flow descriptions and processing model, according to an embodiment of the present invention.

FIG. 2 is a flow diagram illustrating a method for template processing using an extensible pipeline-processing model for XML-based templates according to an embodiment of the invention.

FIG. 3 is an exemplary diagram illustrating an XML DTD (document type definition) of a Process Flow Description Language for data access and variables processing, according to an embodiment of the invention.

FIG. 4 is an exemplary diagram illustrating an XML DTD of a Process Flow Description Language for conditional logic processing, according to an embodiment of the present invention.

FIG. 5 is an exemplary diagram illustrating an XML DTD of a Process Flow Description Language for document transformation processing, according to an embodiment of the invention.

### DETAILED DESCRIPTION OF THE PREFERRED EMBODIMENTS

The present invention relates to systems and methods for document processing using XML-based template server pages. An XML-based Process Flow Description Language (PFDL) according to an embodiment of the invention describes a processing model for specifying a processing sequence of XML-based template sever pages, which supports development of Web-based applications and services. In general, a processing model for processing XML-based template server pages according to an embodiment of the invention is preferably based on an extensible, XML-based, pipeline processing model that specifies a collection of template processors (XML applications) that are executed in a specified sequence for processing XML-based templates, and which can interpret processor-specific XML elements within the templates. For example, a processing model can specify a sequence of conditional logic processing, data access processing, document transformation processing and/or session handling, etc.

Preferably, document processing systems and methods according to the invention are based on template specifications within XML-based templates, wherein the semantics of such template specifications are used to direct the computation of XML template processors. For example, in one embodiment, pipeline process flow descriptions, which are used for directing the computational steps of the XML template processors, are implemented using standard XML syntax of processing instructions (PI) that are specified in the prologs of XML-based templates. In other words, a pipeline processing model according to an embodiment of the present invention is preferably based on a sequence of processing instructions that are specified within an XML-based template to direct the template processing. The processing instructions use standard XML syntax to describe processors and processor-related XML elements that are defined in a doctype attribute. As such, pipeline processing frameworks for processing template server pages according to the invention are extensible, enabling users to define custom XML template processors specified by custom DTDs (document type definition).

It is to be understood that the systems and methods described herein in accordance with the present invention may be implemented in various forms of hardware, software, firmware, special purpose processors, or a combination thereof. Preferably, the present invention is implemented in software as an application comprising program instructions that are tangibly embodied on one or more program storage devices (e.g., hard disk, magnetic floppy disk, RAM, CD Rom, DVD, ROM, etc.), and executable by any device or machine comprising suitable architecture.

It is to be further understood that because the constituent system modules and method steps depicted in the accompanying Figures are preferably implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

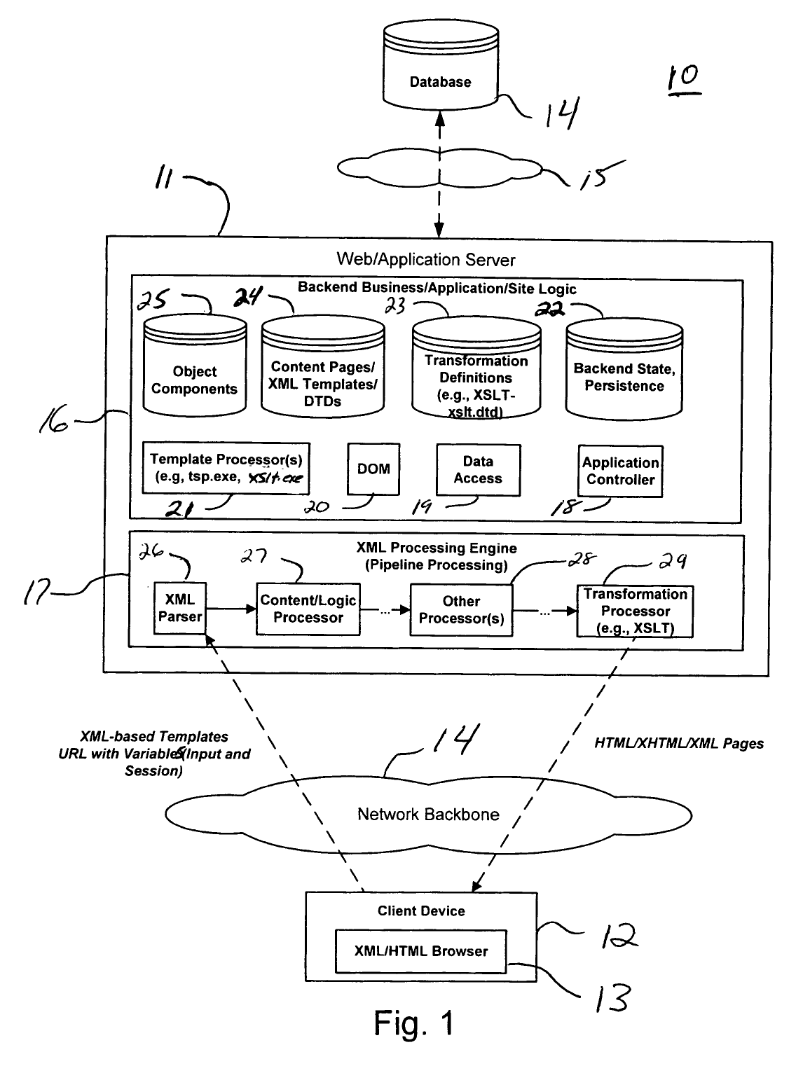

Referring now to FIG. 1, a diagram illustrates a client/server system that provides pipeline processing of XML-based templates based on process flow descriptions, according to an embodiment of the present invention. The exemplary system of FIG. 1 illustrates a Web-based framework, although one of ordinary skill in the art would readily appreciate that the invention can be implemented in other envrionments. In general, the system (10) comprises a web server/application server (11) and a client device (12) (e.g., workstation, portable laptop, PDA, mobile (smart) phone, etc.) including a XML/HTML browser application (13) (although other modalities may be implemented such as WML). The client device (12) can be used to access the server (11) over a network (14) (e.g., Internet, wireless, LAN, WAN, PSTN, etc.). The server (11) can access one or more enterprise databases (e.g., database (14)) such as Oracle, DB2, SQL server, etc. over a network (15) (e.g., LAN), which network can be the same or different from the network (14). The web-based application architecture shown in FIG. 1 is preferably an n-tier application with a browser-based front end, a middle-tier business logic, and backend database and transaction server.

In general, the server (11) comprises backend business/application/site logic (16) (or logic module), which generally includes programming layers/modules that provide known web sever and application server functionalities, and well as the application logic for driving one or more applications/services. Preferably, the overall application architecture of the logic module (16) separates the programming layers for the business logic, content page logic and page presentation logic, as is understood by those of ordinary skill in the art. In addition, the server (11) comprises an XML processing engine (17) that performs pipeline processing of XML-based templates according to the invention.

More specifically, the logic module (16) performs various functions such as driving the application workflow under control of an application controller (18), processing incoming requests (and variables) from client device (12) and mapping such requests to content pages stored in database (24), performing backend database accesses to database (14), for example, via a data access module (19), and maintaining application state and persistence in database(22). The backend logic comprises a plurality of components (25) (e.g., reusable components such as Javabeans, Enterprise Java beans, etc.) that are used to dynamically generate content and provide dynamic access to data sources. The components (25) encapsulate business logic to perform generic tasks such as calling web services or accessing a backend databases (e.g., database (14)), for example.

The application content is preferably authored using XML content pages (and/or other declarative languages) and XML-based templates that are stored in the database (24). The database (24) may further include DTDs associated with the content pages/templates, which are accessible during page processing to interpret elements/tags within such pages/templates. Furthermore, presentation of the content may be specified based on transformation definitions stored in database (23) (e.g., XSLT (Extensible Stylesheet Language Definitions)) that enable transformation of the structure of XML document instances to other structures (e.g., HTML, XHTML, WML, etc.). The database (23) may comprise a plurality of stylesheet files that include coding for performing such transformations and/or coding (XSL) for rendering/presenting the transformed content. The XML template/documents in database (24) can specify links to such stylesheet files and associated DTDs stored in database (23).

The XML processing engine (17) processes XML template pages (24) and/or transformation definitions (23) for providing dynamic generation and/or presentation of e.g., HTML, XML, XHTML content pages. The XML processing engine (17) can use object components (25) (objects/programs associated with the business and data logic) for, e.g., accessing backend information from database (14), changing/accessing application state (22), performing task oriented operations, etc., during processing of an XML template.

It is to be understood that the XML templates (24) may comprise any legal XML document. XML templates are preferably used to describe the content and structure of documents/pages of an application. The XML templates are preferably used for dynamic generation of the front end user interface (e.g., HTML forms). XML templates may contain a query string for accessing data from a database or may contain a stored procedure that is executed by accepting input parameters that are passed to variables defined in the template. In other words, an XML template can be executed by URL with parameter values, and passing the parameters to the stored procedure.

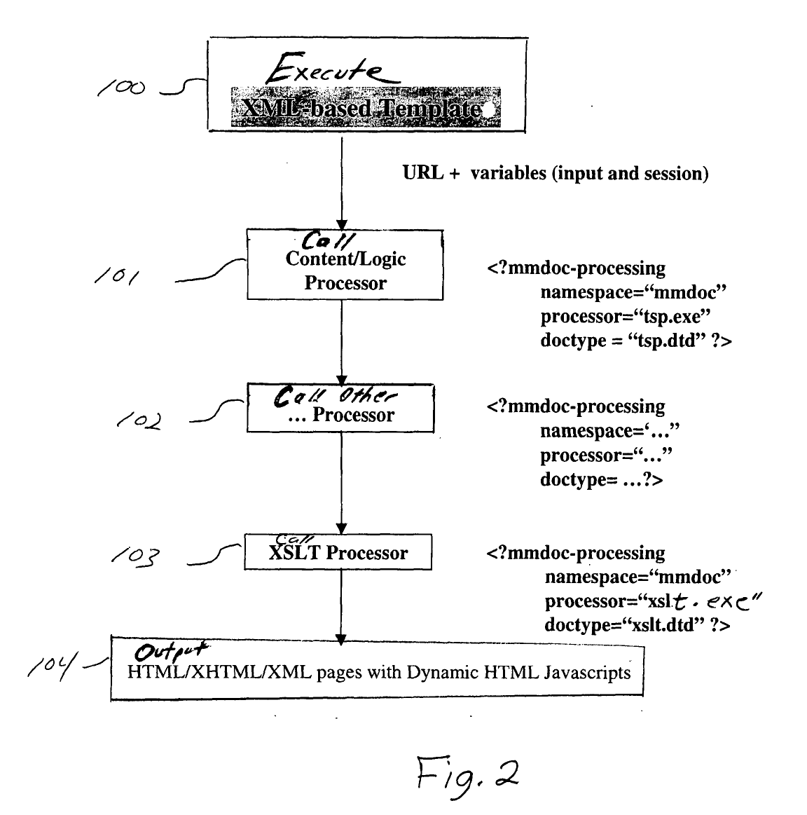

In addition, in accordance with the present invention, one or more XML templates include template specifications (process flow descriptions) that are interpreted to direct the computation of one or more XML template processors (21). In particular, the logic module (16) comprises a plurality of XML processors (21) (or template processing applications) that are invoked and executed in a specified sequence (pipeline processing) by the XML processing engine (17) in accordance with the template specifications for processing/interpreting processor-specific XML elements that are contained within the XML templates. In one embodiment, pipeline process flow descriptions, which are used for directing the computational steps of the XML template processors, are implemented using standard XML syntax of processing instructions (PI) that are specified in the prologs of XML-based templates (the details of which are discussed below with reference to FIGS. 2-5).

By way of example, FIG. 1 illustrates an exemplary pipeline processing by the XML processing engine (17). An XML parser (26) is a processor that is initially invoked to interpret an XML template/document, determine the structure and properties of the data and generate a hierarchically structured tree for downstream processing (and optionally checks XML syntax using a DTD and reports errors).

As illustrated in FIG. 1, the XML parser (26) may receive as input an XML template together with variables (input variables and session variables) received from the client device (12). Such input may be the result, for example, of a user filling an HTML form with input variables (e.g., passwords, username), wherein the HTML form comprises a link to an XML template that is called for processing the input variables by passing the input variables as parameters to the specified XML template.

Then based on processing instructions within the XML template, pipeline processing the XML template may be sequentially performed by a content/logic template processor (27), other processors (28) and a transformation processor (29).

The content/logic processor (27) (e.g., the tsp.exe application from template processor module (21)) is used by the XML processing engine (17) for processing XML elements of XML templates that specify content and logic processing. Such processing includes, for example, processing input parameters, conditional logic processing, processing embedded SQL queries, etc. In addition, other processors (28) may be called to perform other types of user-defined processes such as web service, data access, application programs, etc., as specified in the template specifications.

The transformation processor (29) (e.g., XSLT processor) can be invoked (e.g., xslt.exe from template processor module (21)) for processing XML elements of XML templates that specify document transformation and/or rendering using, for example, the transformation definitions (23) (e.g., XSLT and/or XSL stylesheets). As discussed in further detail below, transformation processing includes, e.g., specification of top-level transformation parameters, specification of client-side javascripts for client-side processing or XSL rendering. In a preferred embodiment, the transformation processor (29) comprises an XSLT Processor that transforms an XML instance into another form. The database (23) includes XSLT definitions, which describe a vocabulary recognized by the XSLT processor (29) to transform the structure of a source file into a different structure suitable for continued downstream processing. A stylesheet can be written with both the transformation vocabulary and formatting semantics vocabulary (e.g., XSL), which is used by a rendering agent to reify abstract expression of format into a particular medium of presentation. The input to the XSLT processor (29) comprises one or more stylesheets and one or more source files. The output of XSLT processor (29) is a result tree of abstract nodes. The result tree output from the transformation processor (29) can be sent directly to the client device (12) for rendering by the client browser (13) based on, e.g., XSL rules specified in the client or based on inserted javascripts. Alternatively, rendered content pages may be sent from the server (11) to the client browser (13).

The system of FIG. 1 may further comprise a DOM (Document Object Model) processor (20) to provide an API that enables control and access of XML tree elements that are exposed as objects. As is known in the art, the DOM is a platform and language-neutral programming interface specification being developed by the World Wide Web Consortium (W3C), which allows programs and scripts to dynamically access and update the content, structure and style of different types of documents (e.g., XML, HTML documents). With DOM, programmers can build documents, navigate their structure, and add, modify, or delete elements and content. Virtually, anything found in an HTML or XML document can be accessed, changed, deleted, or added using DOM.

Therefore, using DOM, during document processing, the logic module (16) can maintain the application state and XML documents in database (22) in a DOM format. The DOM can be used an intermediate model of the application's state that contains the user input, before it is written back to a database. The DOM module (20) creates/modifies a DOM tree, which can be done with the XML parser (26), via the DOM API. The underlying data model may be represented by an XML DOM instance and DOM instances can be created from the application state. The DOM representation of an XML document can be transformed into an HTML or WML presentation via the transformation processor (29) and DOM API to provide a final presentation.

It is to be understood that the pipeline processing performed by XML processing engine (17), as specified by template instructions, can include pipeline processing within templates, wherein processing occurs for elements within one XML template. Alternatively, pipeline processing may occur between templates, wherein one XML template calls/uses another template such that processing continues with instructions of the other template.

FIG. 2 is an exemplary flow diagram illustrating a method for template processing using an extensible pipeline-processing model for XML-based templates according to an embodiment of the invention. Initially, an XML-template is invoked (executed) to perform a particular task (step 100). Preferably, XML template processing is invoked by standard URL (or URN, URI), which describes the address of a desired template and includes input parameters (e.g., variables and session parameters). For example, URL descriptions can be specified in several attributes including, for example, href, action, src, etc. of HTML/XHTML elements in web pages. It is to be understood that step (100) represents one of various stages of processing. For instance, step (100) can represent a situation where an input URL and variables are received in connection with a client request, wherein template processing is invoked based on an XML template specified in the client request. Alternately, step (100) represents a situation where an XML template is invoked in response to a nested element within an XML template that calls another XML template. Indeed, as noted above, pipeline processing may occur within an XML template and/or between XML templates.

After and an XML template is invoked and parsed, pipeline processing (e.g., steps 101-103) is performed in accordance with a sequence of XML processing instructions that are specified within the XML template to specify the template processing.

In accordance with one exemplary embodiment of the invention, the processing instructions are preferably in standard XML syntax of processing instructions and are specifed in the beginning (prolog) of an XML template before the root element in the body of the XML template. The processing instructions are passed to the application using the XML parser and provide special instructions for the application for pipeline processing. By way of example, pipeline processing instructions can start from <?mmdoc-processing namespace=“mmdoc” processor=“tsp.exe” doctype=“tsp.dtd” ?> and end with the processing instruction <?mmdoc-processing namespace=“mmdoc” processor=“xslt.exe” doctype=“xslt.dtd” ?>.

The processing instructions begin with <? following the name of the processing instruction mmdoc-processing. A PITarget is used to identify the application to which the instruction is directed. The processing instructions direct the application on how to process special designed XML elements defined in a doctype description such as the examplary tsp.dtd and xslt.dtd described herein. The attribute processor describes the template processing program name and invoking address. The namespace in the processing instructions are used to direct the patterns of XML elements in templates.

As noted above, a pipeline processing model according to an embodiment of the inveiton utilizes processing instructions that specify a collection of template processors, which are executed in certain sequence to interpret processor-specific XMl elements in templates. The use of XML sytnax of processing instructions to describe the processors and processor-related XML elements defined in doctype attribute of processing instructions, provides extensibility to the pipeline model.

In FIG. 2, the processing instructions in a XML template may include a processing intruction that directs the application to call a content/logic processor for providing content/logic processing (step 101). In the exemplary embodiment, the processing instruction associated with step 101 specifies that the tags/elements of the XML template are interptered in the namespece of mmdoc. In addition, the processsing instruction provides a link (via the processor attribute) to the tsp.exe application in processor module (21), which is used to perform such content/logic processing, and a link (via the doctype attribute) to the associated DTD, tsp.dtd, for specifying the relvant content model.

Further, the processing instructions in the XML template may include other processing intructions that direct the application to call relevant processors for providing other processing tasks, as necessary (step 102). Indeed, there is no limitation in the number of template processors that can be specified using XML processing instructions. Such instructions can be used to provide a hook mechanism to include any user-defined template processor. Indeed, although the exemplary embodiments described herein refer to specific XML-based template processors: tsp.exe for content and logic processing, and xslt.exe for document transformation, nothing herein shall be construed as placing a limitation on the scope of the invention.

Next, the processing instructions in the XML template may include a processing intruction that directs the application to call a transformation processor (e.g., XSLT processor) for providing document transformation (step 103). In the exemplary embodiment, the processing instruction associated with step 103 specifies that the tags/elements of the XML template are interptered in the namespece of mmdoc. In addition, the processsing instruction provides a link (via the processor attribute) to the xslt.exe application in processor module (21), which is used to perform such document transformation processing, and a link (via the doctype attribute) to the associated DTD, xslt.dtd, for specifying the relvant content model.

The output of the transformation processing (step 103) can be any desired document format such as HTML, XHTML, XML, depending on the application, together with embedded javascripts for client-side processing for rendering the docoument (step 104).

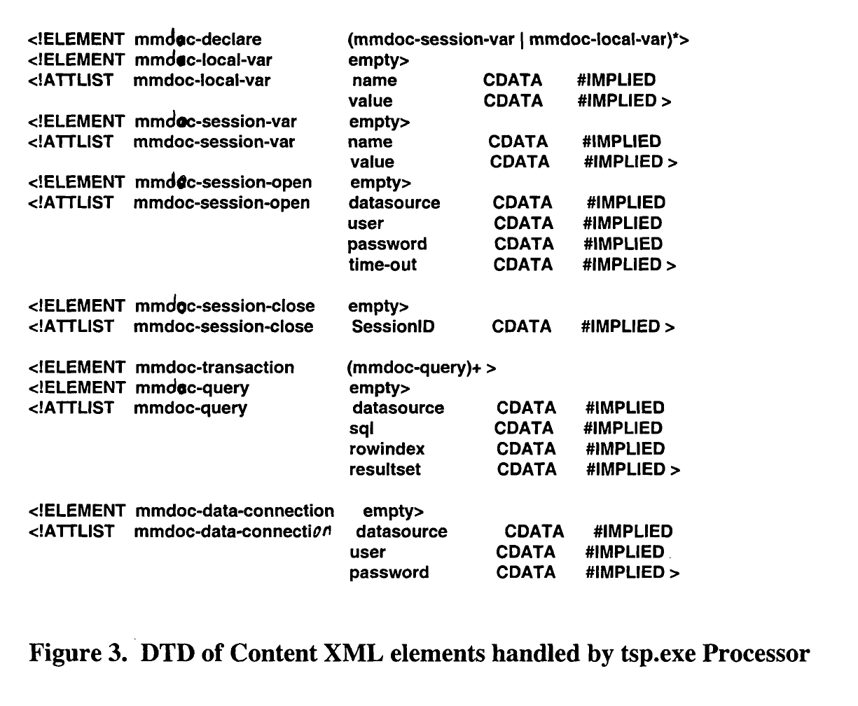

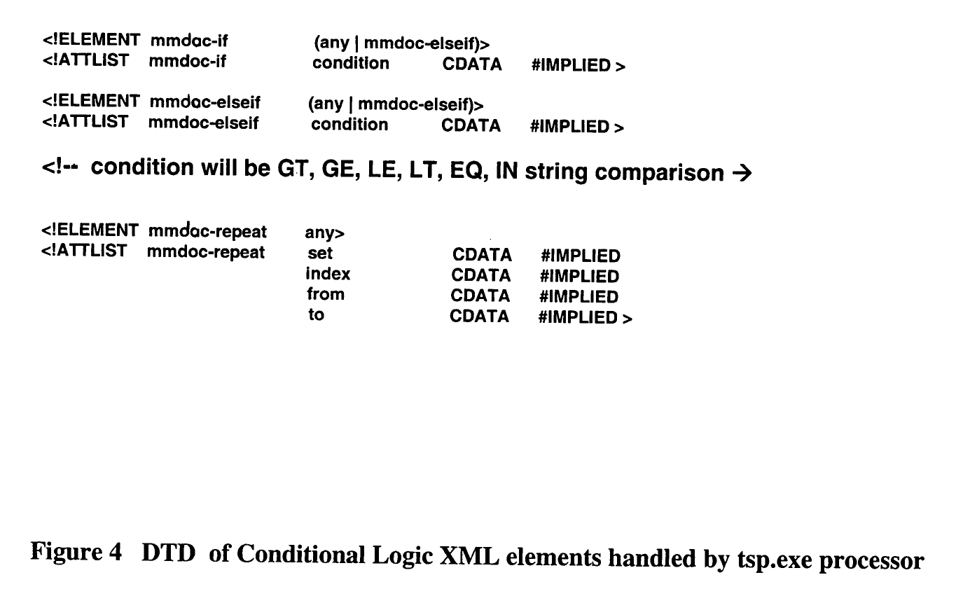

FIG. 3 illustrates an exemplary XML DTD of a Process Flow Description Language for data access and variable processing according to an embodiment of the present invetion. FIG. 4 illustrates an exemplary XML DTD of a Process Flow Description Language for conditional logic processing according to an embodiment of the present invetion. In particular, by way of example, FIGS. 3 and 4 respectively illustrate a content and logical DTD (e.g., tsp.dtd) in the processing instructions of XML templates for specifying content and logic processing.

As is known in the art, the document type definition (DTD) is a method that is used to define a markup language. A DTD (or grammar) is used to specify a content model for each element, wherein the content description is part of the element declaration in the DTD and specifies the order and quantity of elements that can be contained within the element being declared. A DTD can be inserted within a doctype declaration (internal DTD) or stored as a separate file with the extension “.dtd” and pointed to in an XML file. The XML DTD can either be in the prolog of the XML template or it can be in a sepearate file that is referred to in the prolog.

In the exemplary embodiments described herein, the exemplary DTD, tsp.dtd, of FIG. 3 is used by the tsp.exe template processor to process the content XML elements defined in the DTD. The “ELEMENT” declarations identify the names of elements and the nature of the content (content model) of such elements. The ATTLIST declarations identify which elements may have attributes, and specify the name, data type and default value (if any) of each attribute associated with a given element type.

In FIG. 3, an ELEMENT declaration is specified for an element named mmdoc-declare, which comprises a content model that defines the names of allowed (child) elements mmdoc-session-var and mmdoc-local-var, for declaring a block of local and session variables in templates. As is understood by those of ordinary skill in the art, the “*” character of the content model specifies zero or more possibilities for local or session variables.

The ELEMENT declaration for element mmdoc-local-var is used to specify local variables in templates. The content model EMPTY indicates that the element has no content. An ATTLIST declaration for element mmdoc-local-var declares two attributes, name and value, which are both string-types attributes (CDATA) with default value #IMPLIED (attribute value not required, and no default provided).

The ELEMENT declaration for element mmdoc-session-var is used to specify session variables. The session variables store information for the life of the user session to maintain the state Web application with respect to the user session during multiple client-server interactions in the otherwise stateless HTTP protocol. The content model EMPTY indicates that the element has no content. An ATTLIST declaration for element mmdoc-session-var declares two attributes, name and value, which are both string-types attributes (CDATA) with default value #IMPLIED.

An ELEMENT declaration for element mmdoc-session-open, with content model EMPTY, specifies a session start in a web-based application. An ATTLIST declaration for element mmdoc-session-open declares four attributes, datasource, user, password, and time-out, which are each string-types attributes (CDATA) with default value #IMPLIED.

An ELEMENT declaration for element mmdoc-session-close, with content model EMPTY, specifies a session end in a web-based application. An ATTLIST declaration for element mmdoc-session-close declares one attribute, SessionID, which is a string-type attribute with default value #IMPLIED.

An ELEMENT declaration for element mmdoc-transaction, with content model having element mmdoc-query, specifies a sequence of database or any data source operations with data integrity (the + indicates that the element mmdoc-query may be repeated more than once but it must occur once).

An ELEMENT declaration for element mmdoc-query, with content model EMPTY, is used for describing a database query or update based on a database SQL element attribute. An ATTLIST declaration for element mmdoc-query declares four attributes, datasource, sql, rowindex, and resultset, which are each string-types attributes (CDATA) with default value #IMPLIED.

An ELEMENT Declaration for element mmdoc-data-connection, with content model EMPTY, is used for specifying a data source connection. The datasource could be a database or any files. An ATTLIST declaration for element mmdoc-data-connection declares three attributes, datasource, user, and password, which are each string-types attributes (CDATA) with default value #IMPLIED.

Referring now to FIG. 4, an exemplary XML DTD is shown for specifying XML elements for conditional logic processing (which is handled by the tsp.exe processor) ELEMENT declarations for elements mmdoc-if and mmdoc-elseif each comprise a content model including an ANY content model (any content is allowed) or element mmdoc-elseif, which elements are used for describing conditional logic for comparisons. Operators include include GT (greater than), GE(Greater than or equal to), LT(less than), LE(less than or equal to), and IN (member of). ATLIST declarations for elements mmdoc-if and mmdoc-elseif include condition attributes, which are string-type attributes with default values #IMPIED. A condition is a GT (greater than), GE(Greater than or equal to), LT(less than), LE(less than or equal to) and/or IN (member of) string comparison.

An ELEMENT declaration of element mmdoc-repeat comprises an ANY content model, and is used for specifying repeating XML elements based on attributes set, index, from and to values. The attribute set describes a set of items for a repeating reference. The attribute index describes the index variable in the repeating reference. The attributes from and to describe the starting and ending index values. They are optional. In this case, from value is assumed to be 1. The to value is assumed to be the index to the end of set values.

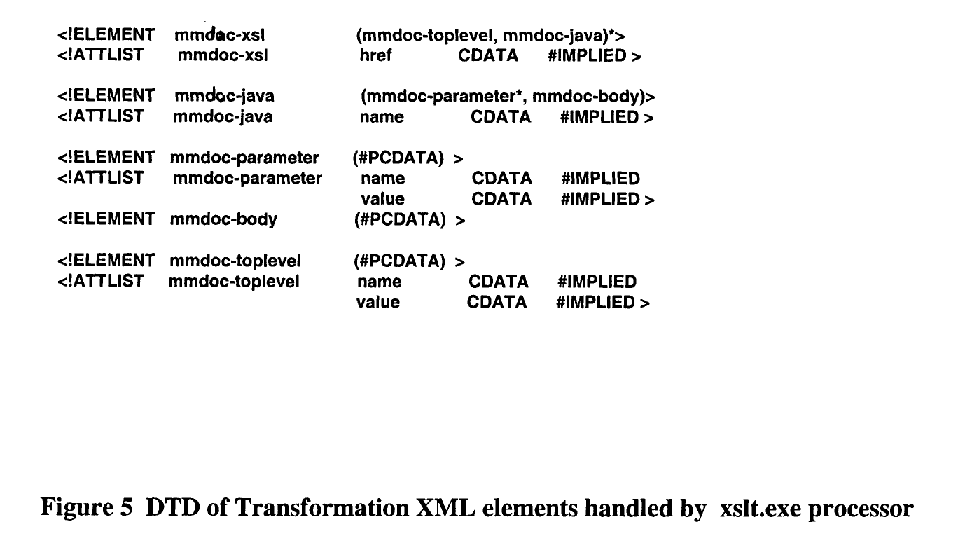

FIG. 5 illustrates an exemplary XML DTD (e.g., (xslt.dtd) of a Process Flow Description Language for specifying document transformation and outputs with client-side javascripts, according to an embodiment of the invention. As decribed above in accordance with the exemplary embodiments of FIGS. 1 and 2, the xslt.exe template processor is invoked to process the XML elements in template server pages according to the model specified by the xslt.dtd.

An ELEMENT declaration for element mmdoc-xsl comprises a content model with child elements mmdoc-toplevel and mmdoc-java, wherein the mmdoc-xsl element describes an XSLT transformation, the mmdoc-toplevel element describes top-level input parameters to the XSLT transformation specification and the mmdoc-java element describes client-side JavaScript, and wherein the comma indicates that the elements mmdoc-toplevel and mmdoc-java must occur once in the order declared and the * indicates that there can be zero or more ordered pairs of such elements. An ATTLIST declaration for element mmdoc-xsl declares an attribute href, which is a string-type attribute (CDATA) with default value #IMPLIED, which is used to provide a link to e.g., a stylesheet.

An ELEMENT declaration for element mmdoc-toplevel indicates that the element content contains parsed character data (#PCDATA). An ATTLIST declaration for element mmdoc-toplevel declares two attributes, name and value, which are each string-types attributes (CDATA) with default value #IMPLIED.

An ELEMENT declaration for element mmdoc-java indicates that the element content contains two child elements mmdoc-parameter and mmdoc-body, separated by a comma which indicates that each element must occur at least one in the specified order, and wherein the * denotes that there can be zero or more mmdoc-parameter. An ATTLIST declaration for element mmdoc-parameter declares two attributes, name and value, which are each string-types attributes (CDATA) with default value #IMPLIED.

An ELEMENT declaration for element mmdoc-body indicates that the element content contains parsed character data (#PCDATA).

It is to be appreciated that the present invention may be implemented for various Web applications. One such application is product configuration. As is known in the art, web-based product configuration applications enable businesses to market complex customizable products and services using electronic commerce. Such applications allow users to design configurable products as desired, whereby users can configure customized products, automatically view design and pricing changes as product configuration modifications are made, and view a model of the item being created as the user selects different options throughout the configuration process.

A web-based product configuration application according to the present invention employs a framework for pipeline processing of XML template server pages to perform various product configuration tasks (which are specified in XML templates) such as configuration computation, transformation, connection and interaction. Web-based XML computation for document processing includes data source connection, data accessing, document transformation, interaction with web clients. The application can be executed from a Web browser and allows the user to execute product configuration concurrently or independently in either client/server or thin web client environments.

Although illustrative embodiments have been described herein with reference to the accompanying drawings, it is to be understood that the invention is not limited to the precise system and method embodiments described herein, and that various other changes and modifications may be affected therein by one skilled in the art without departing form the scope or spirit of the invention. All such changes and modifications are intended to be included within the scope of the invention as defined by the appended claims.

What is claimed is:

1. A method for processing documents, comprising the steps of:
executing a document template;
obtaining template processing specifications that are specified within the document template to provide instructions for processing elements of the document template; and
processing the elements within the document template by sequentially calling template processors that are specified in the template processing specifications.

2. The method of claim 1, wherein the step of executing a document template is performed by invoking the the document template through a URI (universal resource identifier) comprising an address of the document template and input variables.

3. The method of claim 1, wherein the document template comprises an extensible markup language (XML) template, and wherein the template processing specifications are extensible.

4. The method of claim 1, wherein the template processing specifications comprise processing instuctions that are specified using XML syntax in a prolog of the document template.

5. The method of claim 1, wherein the template processing specifications comprise an attribute that specifies a template processor and invoking address.

6. The method of claim 5, wherein the template processing instructions further comprise a grammar, or an attribute that specifies a grammar and invoking address, wherein the grammar enables an corresponding processor to process related elements in the document template.

7. The method of claim 6, wherein the grammar compries a XML-based document type definition (DTD).

8. The method of claim 1, wherien the step of processing the elements within the document template, comprises providing a pipline sequence of processing inlcuding conditional logic processing, data acccess processing, document transformation processing and any combination thereof.

9. The method of claim 1, wherein the step of processing the elements within the document template, comprises executing a content and logic template processor for processing elements associated with content and logic processing.

10. The method of claim 9, wherein elements associated with content and logic processing comprise: (i) elements for describing conditional logic of comparison, wherein operators include GT(greater than), GE(Greater than or equal to), LT(less than), LE(less than or eaual to) and IN (member of); (ii) an element for specifying a repeating element; (iii) an element for declaring a block of local and session variables in templates; (iv) an element for specifying local variables in document templates; (v) an element for describing session variables; (vi) elements for specifying a session start and session end; (vii) an element for specifying data source connection; (viii) an element for specifying a sequence of database or any data source operations with data integrity; (xi) an element for describing database query or update; or any combination thereof.

11. The method of claim 1, wherein the step of processing the elements within the document template, comprises executing a transformation processor for processing elements associated with document transformation and outputting rendering scripts.

12. The method of claim 11, wherein the elements associated with document transformation and outputting rendering scripts comprise: (i) an element for describing a document transformation; (ii) an element for describing top-level input parameters for the document transformation; (iii) an element for describing a script; or any combination thereof.

13. The method of claim 11, wherein the transformation processor comprises an XSLT (extensible stylesheet language transformation) processor and wherein the scripts comprise javascripts.

14. A process flow processing model for processing document templates, wherein the model is specified by extensible process flow descriptions within a document template that specify a pipeline sequence of template processors that are executed in a specified sequence for processing processor-specific elements within the document template.

15. The processing flow model of claim 14, wherein the document templates comprise XML templates that are invoked by URI (uniform resource identifier), which describe the address of the templates and the input parameters.

16. The processing model of claim 15, wherein the XML templates comprise legal XML documents that optionally comprise XML processing instructions for directing the processing sequence of XML elements within the XML templates.

17. The processing model of claim 16, wherein the pipeline sequence is specified by a sequence of the XML processing instructions that are specified in a prolog of an XML template to specify the processing of the XML template.

18. The processing model of claim 17, wherein a sequence of processing instructions begins with a processing instruction that specifies content and logic processing and ends with a processing instruction that specifies document transformation.

19. The processing model of claim 18, wherein a processing instruction comprises an attribute that specifies a template processor and its location, which is invoked for processing template processor-specific elements in the XML template, and wherein the processing instruction comprises an attribute that specifies a grammar that describes the template processor-specific elements.

20. A program storage device readable by machine, tangibly embodying a program of instructions executable by the machine to perform method steps for processing documents, the method steps comprising:
executing a document template;
obtaining template processing specifications that are specified within the document template to provide instructions for processing elements of the document template; and
processing the elements within the document template by sequentially calling template processors that are specified in the template processing specifications.

21. The program storage device of claim 20, wherein the instructions for executing a document template comprise instructions for invoking the document template through a URI (universal resource identifier) comprising an address of the document template and input variables.

22. The program storage device of claim 20, wherein the document template comprises an extensible markup language (XML) template, and wherein the template processing specifications are extensible.

23. The program storage device of claim 20, wherein the template processing specifications comprise processing instuctions that are specified using XML syntax in a prolog of the document template.

24. The program storage device of caim 20, wherein the template processing specifications comprise an attribute that specifies a template processor and invoking address.

25. The program storage device of claim 24, wherein the template processing instructions further comprises a grammar, or an attribute that specifies a grammar and invoking address, wherein the grammar enables an corresponding processor to process related elements in the document template.

26. The program storage device of claim 25, wherein the grammar compries a XML-based document type definition (DTD).

27. The program storage device of claim 20, wherien the instructions for processing the elements within the document template, comprises instructions for providing a pipline sequence of processing including conditional logic processing, data acccess processing, document transformation processing and any combination thereof.

28. The program storage device of claim 20, wherein the instructions for processing the elements within the document template, comprises instructions for executing a content and logic template processor for processing elements associated with content and logic processing.

29. The program storage device of claim 28, wherein elements associated with content and logic processing comprise: (i) elements for describing conditional logic of comparison, wherein operators include GT(greater than), GE(Greater than or equal to), LT(less than), LE(less than or eaual to) and IN (member of); (ii) an element for specifying a repeating element; (iii) an element for declaring a block of local and session variables in templates; (iv) an element for specifying local variables in document templates; (v) an element for describing session variables; (vi) elements for specifying a session start and session end; (vii) an element for specifying data source connection; (viii) an element for specifying a sequence of database or any data source operations with data integrity; (xi) an element for describing database query or update; or any combination thereof.

30. The program storage device of claim 20, wherein the instructions for processing the elements within the document template, comprise instructions for executing a transformation processor for processing elements associated with document transformation and outputting rendering scripts.

31. The program storage device of claim 30, wherein the elements associated with document transformation and outputting rendering scripts comprise: (i) an element for describing a document transformation; (ii) an element for describing top-level input parameters for the document transformation; (iii) an element for describing a script; or any combination thereof.

32. The program storage device of claim 30, wherein the transformation processor comprises an XSLT (extensible Stylesheet Language Transformation) processor and wherein the scripts comprise javascripts.

33. A system for processing document templates, comprising a server, wherein the server comprises a plurality of document templates for describing content and structure of an application, and a template processing engine for providing server-side processing of one or more document templates, wherein the server implements a process flow processing model for processing a document template, wherein the model is specified by extensible process flow descriptions within the document template that specify a pipeline sequence of template processors that are executed in a specified sequence by the template processing engine for processing processor-specific elements within the document template.
